(19) United States
(12) Patent Application Publication
(10) Pub. No.: US 2021/0384636 A1
(43) Pub. Date: Dec. 9, 2021

(54) PARALLEL PLATE UNIT CELL FOR A PARALLEL PLATE ARRANGEMENT

(71) Applicant: Telefonaktiebolaget LM Ericsson (publ), Stockholm (SE)

(72) Inventors: Oscar QUEVEDO-TERUEL, STOCKHOLM (SE); Martin MATTSSON, TÄBY (SE); Astrid ALGABA BRAZALEZ, Göteborg (SE); Lars MANHOLM, Göteborg (SE); Kristoffer ANDERSSON, Göteborg (SE); Martin JOHANSSON, MÖLNDAL (SE)

(73) Assignee: Telefonaktiebolaget LM Ericsson (publ), Stockholm (SE)

(21) Appl. No.: 17/288,332

(22) PCT Filed: Oct. 24, 2018
(86) PCT No.: PCT/EP2018/079147

§ 371 Date: Apr. 23, 2021

(51) Int. Cl. H01Q 15/04

(52) U.S. Cl. CPC H01Q 15/04

(57) ABSTRACT

There is provided a parallel plate unit cell for a parallel plate arrangement. The parallel plate unit cell comprises a top layer, and a bottom layer. Each of the top layer and the bottom layer has a respective metasurface. The top layer and the bottom layer are arranged in a parallel plate configuration with respect to each other such that the metasurfaces face each other. The top layer and the bottom layer are physically separated by a gap. The gap at least partly is filled with a material having a refractive index n1, where n1>1.2.

### TECHNICAL FIELD

Embodiments presented herein relate to a parallel plate unit cell for a parallel plate arrangement. Embodiments presented herein further relate to a parallel plate arrangement comprising such a parallel plate unit cell. Embodiments presented herein further relate to a method for manufacturing such a parallel plate unit cell.

### BACKGROUND

Metasurface technologies for waveguides, such as gap waveguides or glide symmetric waveguides, exhibit special electromagnetic properties. These electromagnetic properties can be utilized in the design of low loss transmission lines, passive radio frequency (RF) components such as filters or power dividers. The electromagnetic properties can be utilized to remove leakage in waveguide joints, for example via special pin-flanges or glide-symmetric holey flanges, or to create different types of antennas, such as slot array antennas or lens antennas.

FIG. 1 illustrates an example of a parallel plate unit cell 10 for a parallel plate arrangement, where the parallel plate unit cell 10 is provided as a holey unit cell. FIG. 1(a) is a perspective view of the parallel plate unit cell 10 in its isolation. FIG. 1(b) is a perspective view of the top layer 110 (solid lines) of the parallel plate unit cell 10 and indicates how the top layer 110 of several parallel plate unit cells 10 can be arranged periodically to form a part 20a of a parallel plate arrangement (dotted lines). FIG. 1(c) is a perspective view of the bottom layer 120 (solid lines) of the parallel plate unit cell 10 and also indicates how the bottom layer 120 of several parallel plate unit cells 10 can be arranged periodically to form another part 20b of the parallel plate arrangement (dotted lines). A parallel plate arrangement may thus comprise several parallel plate unit cells 10 arranged periodically, where the top layer 110 and the bottom layer 120 face each other as in FIG. 1(a). Referring back to FIG. 1(a), the parallel plate unit cell 10 thus comprises a top layer 110, and a bottom layer 120. Metasurface 150 of the bottom layer 120 exhibits a first recess 160, and metasurface 140 of the top layer 110 exhibits a set of second recesses 170a, 170b, 170c (a fourth second recess is in FIG. 1(a) hidden but visible in FIG. 1(b)). Each of the top layer 110 and the bottom layer 120 forms part of a respective metasurface 140, 150. The top layer 110 and the bottom layer 120 are arranged in a parallel plate configuration with respect to each other such that the metasurfaces 140, 150 face each other. The top layer 110 and the bottom layer 120 are physically separated by a gap g filled with air, and thus the gap g is an air gap.

One design parameter in these technologies is the air gap between the metal layers (i.e., the gap g between the top layer 110 and the bottom layer 120) composing the parallel plate unit cell 10. The value of the height of the air gap is a contributing factor when setting the operating bandwidth of the parallel plate unit cell as used in the parallel plate arrangement. The air gap can become a limiting practical factor, especially when the parallel plate arrangement is to be used for higher frequency since the physical dimensions of the parallel plate unit cell 10 needs to be decreased as the operating frequency increases, and manufacturing tolerances and/or assembly tolerances become more sensitive.

Relevant discrepancies between simulation and measurement results due to manufacturing and assembly tolerances concerning the air gap between the top and bottom layers that thus constitute a metasurface prototype have previously been investigated. At high frequencies, any possible misalignment between those metal layers can provoke, for example, a shift in the operating frequency band or impedance mismatch that degrades the component performance.

Therefore, very accurate manufacturing techniques, such as milling, are required to ensure that the parallel plate unit cells of the parallel plate arrangement have the required air gap. In practice, it is can be difficult to achieve the same fixed air gap value when assembling and disassembling the parallel plate arrangement, thus affecting the repeatability of the parallel plate arrangement response. The sensitivity to the air gap tolerances causes that this type of metasurface technologies to become difficult to be mass-produced in a cost-effective way whilst exhibiting good performance at the same time.

Hence, there is still a need for an improved parallel plate unit cell.

### SUMMARY

An object of embodiments herein is to provide improved parallel plate unit cells and parallel plate arrangements not suffering from the issues noted above, or at least where the above noted issues are mitigated or reduced.

In general terms, the object is achieved by a parallel plate unit cell as disclosed herein, by a parallel plate arrangement as disclosed herein, and by a method of manufacturing a parallel plate unit cell as disclosed herein.

According to a first aspect there is presented a parallel plate unit cell for a parallel plate arrangement. The parallel plate unit cell comprises a top layer, and a bottom layer. Each of the top layer and the bottom layer form part of a respective metasurface. The top layer and the bottom layer are arranged in a parallel plate configuration with respect to each other such that the metasurfaces face each other. The top layer and the bottom layer are physically separated by a gap. The gap at least partly is filled with a material having a refractive index n1, where n1>1.2.

According to a second aspect there is presented a parallel plate arrangement. The parallel plate arrangement comprises at least one first parallel plate unit cell according to the first aspect. The parallel plate arrangement comprises at least one second parallel plate unit cell according to the first aspect, but wherein the gap at least partly is filled with a material having a refractive index n3, where n3≠n1.

According to a third aspect there is presented a method of manufacturing a parallel plate unit cell according to the first aspect. The method comprises providing the top layer and the bottom layer of the parallel plate unit cell. The method comprises arranging the top layer and the bottom layer in the parallel plate configuration with respect to each other. The method comprises at least partly filling the gap with the material having a refractive index n1, where n1 >1.2.

Advantageously this provides a parallel plate unit cell having an effective refractive index that, by means of the material having a refractive index n1, can be controlled in a more efficient manner than if the gap was filled only with air.

Advantageously this provides a parallel plate unit cell enabling a larger range of effective refractive indices than if the gap was filled only with air.

Advantageously this provides a parallel plate unit cell where the gap between the top plate and the bottom plate is mechanically stabilized by means of the material having a refractive index n1.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a perspective view of a parallel plate unit cell according to prior art;

FIGS. 2, 7, 8 are perspective views of parallel plate unit cells according to embodiments;

FIG. 3 schematically shows effective refractive index as a function of frequency for different gap values and materials provided in the gap according to embodiments;

FIGS. 4 and 5 schematically illustrate a parallel plate arrangement according to embodiments;

FIG. 6 schematically illustrates us of a parallel plate arrangement as an antenna lens according to an embodiment; and

FIG. 9 is a flowchart of methods according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

Embodiments disclosed herein relate to a parallel plate unit cell for a parallel plate arrangement. Embodiments disclosed herein further relate to a parallel plate arrangement 200 comprising such a parallel plate unit cell. Embodiments disclosed herein further relate to manufacturing such a parallel plate unit cell.

Reference is made to FIG. 2 schematically illustrating a parallel plate unit cell bow according to an embodiment. The parallel plate unit cell 100a comprises a top layer 110 and a bottom layer 120. The top layer 110 at its downwards-facing surface forms part of a metasurface 140 and the bottom layer 120 at its upwards-facing surface forms part of another metasurface 150. Thus, each of the top layer 110 and the bottom layer 120 forms part of a respective metasurface 140, 150. The top layer 110 and the bottom layer 120 are arranged in a parallel plate configuration with respect to each other such that the metasurfaces 140, 150 face each other. The top layer 110 and the bottom layer 120 are physically separated by a gap g. The gap g at least partly is filled with a material 130 having a refractive index n1, where n1>1.2.

In some aspects the parallel plate unit cell 100a thus corresponds to one unit cell of a parallel plate arrangement. This will be further be elaborated on below. The parallel plate unit cell 100a in some aspects define a metasurface structure where a material 130 having a refractive index n1>1.2 is used to fill all, or a part of, the present air gap in order to facilitate the assembly of a parallel plate arrangement 200 whilst avoiding possible gap misalignments both lateral and vertical, without losing the special electromagnetic properties of the metasurface.

Embodiments relating to further details of the parallel plate unit cell 100a will now be disclosed.

As noted above, the refractive index n1 of the material at least partly filling the gap g is larger than 1.2; that is n1>1.2. Depending on the use case and application of the parallel plate unit cell 100a there could be further demands that require the refractive index n1 to be even higher. Particularly, according to an embodiment a material with a refractive n1≥1.5, or even n1≥1.7, is selected to at least partly fill the gap g.

There could be different types of materials that at least partly fill the gap. In some examples the material is a dielectric material, a magnetic material, or a metamaterial. Non-limiting examples of dielectric materials that could be used are Rogers RT/duroid 5880, Nitto, and Premix.

The material 130 having the refractive index n1 at least partly filling the gap g helps stabilizing the gap g between the top plate 110 and the bottom plate 120.

There may be different ways for the gap g to be at least partly filled with the material 130 having a refractive index n1>1.2.

In some aspects the whole gap g is filled with the material. That is, according to an embodiment, the gap g is fully filled with the material 130.

In some aspects less than the whole part of the gap g filled with the material 130. That is, according to an embodiment, the gap g only partly is filled with the material 130.

In case less than the whole part of the gap g filled with the material 130, the remaining part of the gap g could be filled with another material such that the gap g as a whole is filled with two or more types of materials. That is, according to an embodiment, the material 130 is denoted a first material, and the refractive index n1 is denoted a first refractive index, and the gap g further is partly filled with a second material having a second refractive index n2>1.2, and where n2≠n1. This second material could be a dielectric material, a magnetic material, or a metamaterial. In another embodiment the remaining part of the gap g is filled with air, or some other material with a refractive index≤1.2.

There could be different types of materials of which the top layer 110 and the bottom layer 120 are made. According to an example the top layer 110 and the bottom layer 120 are of a metal material. According to an example the top layer 110 and the bottom layer 120 are made of metallized plastics, where the surface is metallic. According to another example the top layer 110 and the bottom layer 120 are provided with meandered microstrip lines.

There could be different ways to arrange the top layer 110 and the bottom layer 120 with respect to each other in the parallel plate unit cell 100a . In some aspects the metasurface 150 of the bottom layer 120 is glide-symetrically arranged with respect to the metasurface 140 of the top layer 110.

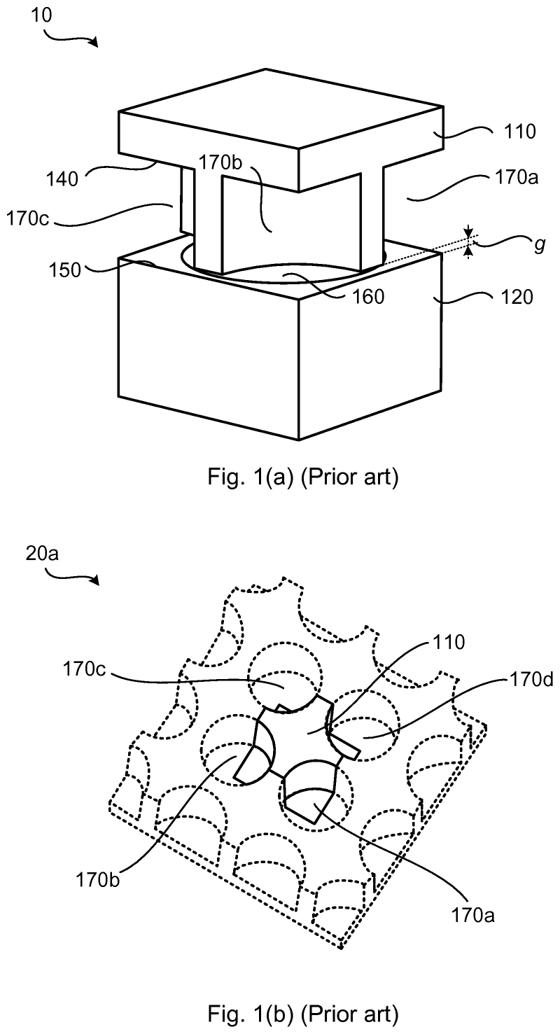

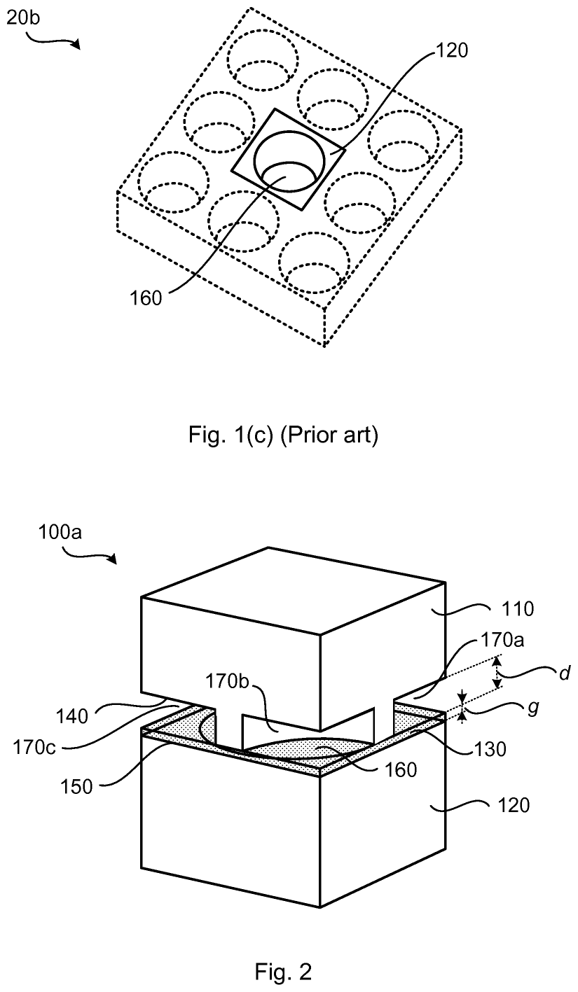

For example, according to the illustrative example of FIG. 2, the metasurface 150 of the bottom layer 120 exhibits a first recess 160, and the metasurface 140 of the top layer 110 exhibits a set of second recesses 170a, 170b, 170c (a fourth second recess is in the view shown in FIG. 2 hidden). The set of second recesses 170a, 170b, 170c could then be glide-symmetrically arranged with respect to the first recess 160. In this respect, in some aspects the recesses 170a, 170b, 170c in the top layer 110 form further recesses (circular in the example of FIG. 2) when several parallel plate unit cells 100a are arranged periodically, as in FIG. 1(b). These further recesses are identical to the recesses in the bottom layer 120 as in FIG. 1(c), only shifted half a period in both horizontal directions.

There could be different depths d of the recesses. In general terms, the value of d should be selected based on the intended operating frequency of the final structure (such as on the intended operating frequency of the parallel plate arrangement 200). Thus, the value of d should be relative to the wavelength (λ) of the operating frequency, such as the highest frequency of operation. According to one example, each recess in the set of second recesses 170a, 170b, 170c as well as the first recess 160 has a depth d, where the depth d takes a value in the interval [0.1 mm, 1.0 mm]. This assumes an operating frequency of, or close to, 30 GHz. Other operating frequencies would thus result in other ranges for the value of the depth d.

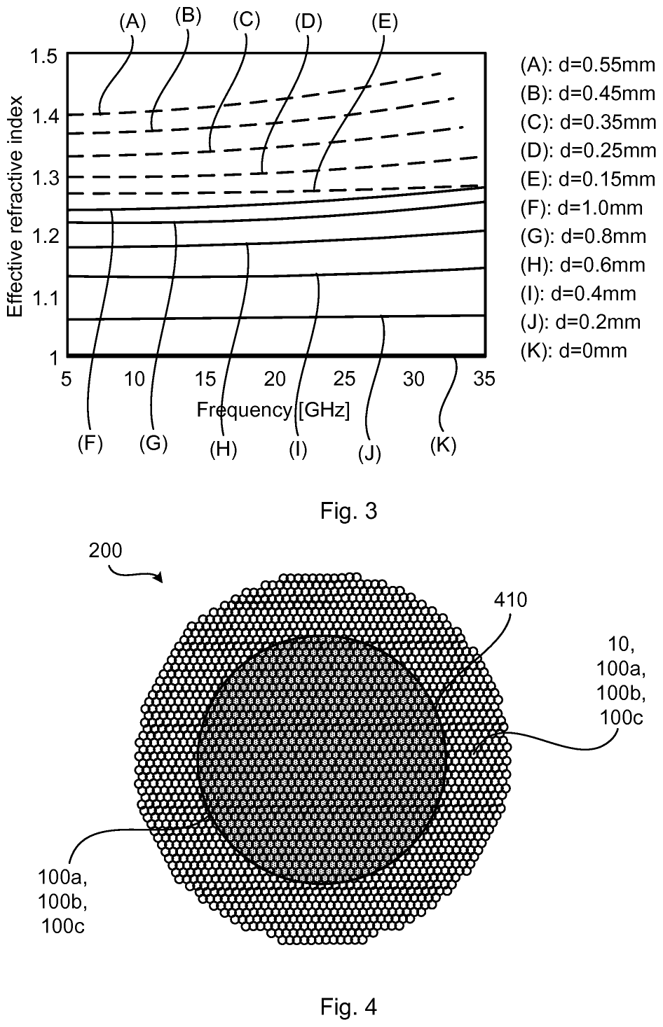

Intermediate reference is made to FIG. 3. FIG. 3 illustrates the effective refractive index as a function of frequency for different gap values and materials provided in the gap. In more detail, FIG. 3 shows the resulting effective refractive index for the parallel plate unit cell 10, 100a as a whole for different values of the depth d and with respect to frequency for cases (F)-(K) where the gap g is filled with air (such as in FIG. 1) and cases (A)-(E) where the gap g is filled with a dielectric material (such as in FIG. 2) and where the parallel plate unit cell 10, 100a is a holey unit cell. It follows from FIG. 3 that using air to fill the gap g, an effective refractive index in the range between 1 and about 1.27 can be achieved (for this set of values of gap g, periodicity and recess radius), and that using a dielectric material to fill the gap g, an effective refractive index in the range between 1.27 and about 1.47 can be achieved (for this material, which has a relative dielectric constant ϵr of 2.2 (so n1=√(2.2)=1.48 in this example)). Thus, an effective refractive index in the range between 1 and about 1.47 can be achieved. With the combination of the material 130 having the refractive index n1 in the gap g and metasurface the effective refractive index can be controlled in an efficient manner. A large range of effective refractive index can be achieved by the coarse variation of the material 130 having the refractive index n1, while the effective refractive index can be fine-tuned with the metasurface structure (such as by the value of d).

In some aspects, at least one parallel plate unit cell 100a is combined with another at least one parallel plate unit cell 10,000a in a parallel plate arrangement 200, for example in the same way as for the parallel plate unit cell 10 in FIGS. 1(b) and 1(c) but where parallel plate unit cells with at least two different values of the refractive index are used.

Hence, according to some aspects there is provided parallel plate arrangement 200 comprising at least one first parallel plate unit cell 100a as disclosed above, and at least one second parallel plate unit cell 10, 100a as disclosed above, but wherein the gap g (i.e., the gap for the at least one second parallel plate unit cell 10, 100a) at least partly is filled with a material having a refractive index n3, where n3≠n1. Hence, the parallel plate arrangement 200 would comprise one or more parallel plate unit cells with a gap g at least partly filled with a material 130 having a refractive index n1>1.2, and one or more parallel plate unit cells with air or another material (such as foam) filling the gap g. That is according to an embodiment, n3<1.2, for example n3=1.

The parallel plate arrangement may thus comprise several parallel plate unit cells 10, 100a arranged periodically. Thereby, two or more parallel plate unit cells can be used to build up a periodic structure that modulates the effective refractive index by modifying some of the design parameters and thereby create a parallel plate arrangement 200 that makes use of that property like for example lens antennas. Particularly, according to an embodiment, the parallel plate arrangement 200 comprises a plurality of first parallel plate unit cells 100a and a plurality of second parallel plate unit cells 10, 100a .

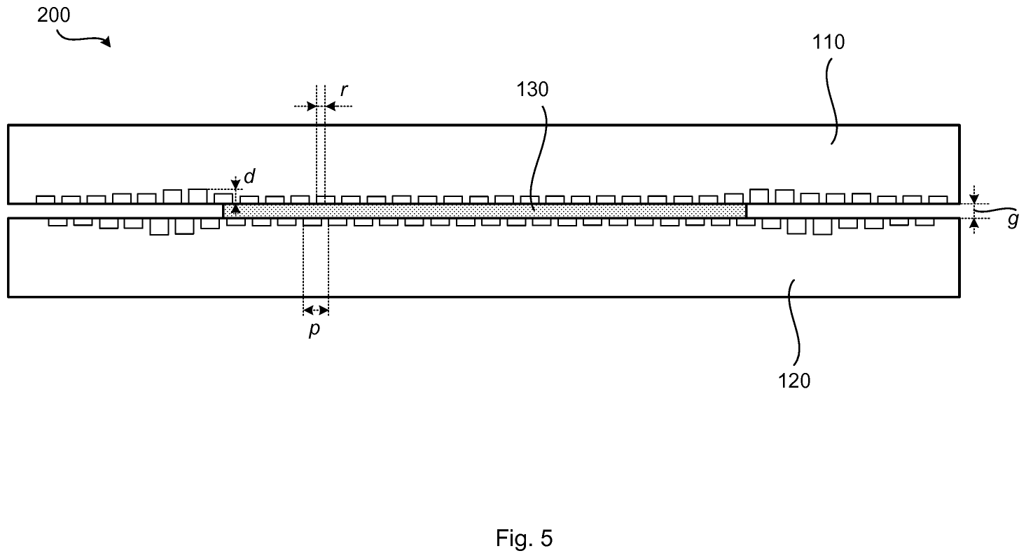

Intermediate reference is made to FIGS. 4 and 5. FIG. 4 schematically illustrates a top view of a parallel plate arrangement 200 according to an embodiment. In more detail, FIG. 4 shows the top view of the parallel plate arrangement 200 provided as a glide-symmetric lens with a ring of the material 130 having the refractive index n1>1.2 covering a certain area from the center. FIG. 5 schematically illustrates a cross-sectional side view of part of the parallel plate arrangement 200 of FIG. 4. In the examples of FIGS. 4 and 5 the recesses are of different depths d, but of the same radius r. Individual parallel plate unit cells are separated by, and hence have a periodicity of, a factor p.

By metasurface is generally meant a periodic structure, such that the parallel plate arrangement 200 would be composed of parallel plate unit cells of a single type, and where the parallel plate unit cells are arranged in a periodic manner. When a lens, or other type of parallel plate arrangement 200, of metasurfaces is built, this implies that the strict periodicity is broken up by slowly changing the geometry of the parallel plate unit cells as a function of position in the parallel plate arrangement 200, thus creating a “quasi-periodic” structure. In FIG. 5, the unit cell type is abruptly changed between the region of the parallel plate arrangement 200 where the gap g is filled with the material and the region of the parallel plate arrangement 200 where the gap g is filled with air.

Hence, in some examples (as in FIGS. 4 and 5) a disk 410 is used to at least partly fill gap g with the material 130 having the refractive index n1>1.2. That is, according to an embodiment the gap g separating the top layers 110 and the bottom layers 120 of all the first parallel plate unit cells 100a at least partly is filled by a disk 410 of the material 130 having the refractive index n1.

Further in this respect, the disk 410 can have a varying height, covering in some parts the full gap g and in other parts only partially filling the gap g, depending on the application and requirements.

Although only a single disk 410 is illustrated in FIGS. 4 and 5, there could also be a second disk of another material provided in the gap g and at least partly overlapping with the disk 410 of the material 130 having the refractive index n1. Denote the material a first material, and the refractive index n1 a first refractive index, and the disk 410 a first disk 410. Then, according to an embodiment, when the gap g separating the top layers 110 and the bottom layers 120 of all the first parallel plate unit cells 100a only partly is filled by the first disk 410, the gap g of at least some of the first parallel plate unit cells 100a further is partly filled by a second disk of a second material having a second refractive index n2, where n2>1.2, and where n2≠n1. Additionally or alternatively, there might be one or more concentric rings of another material provided in the gap g outside the disk ₄10 of the material 130 having the refractive index n1.

With respect to what has been disclosed above, in some examples the metasurfaces 150 of each of the bottom layers 120 are glide-symmetrically arranged with respect to the metasurfaces 140 of each of the top layers 110. But any type of metasurface structure comprising parallel plate unit cell where there is a gap g present can make use of the material 130 having the refractive index n1 to at least partly fill the gap g in order to facilitate the parallel plate arrangement 200.

With further respect to what has been disclosed above, in some examples the metasurface 150 of each bottom layer 120 exhibits a first recess 160, and the metasurface 140 of each top layer 110 exhibits a set of second recesses 170a, 170b, 170c, and the set of second recesses 170a, 170b, 170c is glide-symmetrically arranged with respect to the first recess 160.

With further respect to what has been disclosed above, in some examples each recess in the set of second recesses 170a, 170b, 170c as well as the first recess 160 has a depth d, the depth d taking a value in the interval [0.1 mm, 1.0 mm], assuming an operating frequency of, or close to, 30 GHz, and thus where other operating frequencies would result in other ranges for the value of the depth d.

Not all the parallel plate unit cells 10, 100a need to have first and second recesses 160, 170a, 170b, 170c of the same depth d. That is, according to an embodiment the parallel plate arrangement 200 comprises parallel plate unit cells 10, 100a with mutually different values of the depth d. This is illustrated in the example of FIG. 5, where not all recesses are of the same depth.

There could be different examples and uses of the parallel plate arrangement 200. According to an embodiment the parallel plate arrangement 200 forms an antenna lens (as in FIGS. 4 and 5), such as a Luneburg lens, a Maxwell fish eye lens, a Gutman lens, an Eaton lens, a 90 degrees rotation lens, an invisible sphere lens, or an optically transformed lens.

When used as a lens, the material at least partly filling the gap g changes the phase velocity of the propagating wave as fed to the parallel plate arrangement 200, which is taken into account when analyzing the dimensioning of the parallel plate unit cell 100a (in terms of values, of g, d, n1, n2, n3, p, and/or r) as needed to achieve the required effective refractive index of the lens. A simple metasurface structure with small effect on the effective refractive index can be achieved in lens applications where large variations are required, by using a plurality of parallel plate unit cells 100a , 100b, 100c with different combinations of values of g, d, n1, n2, and/or n3.

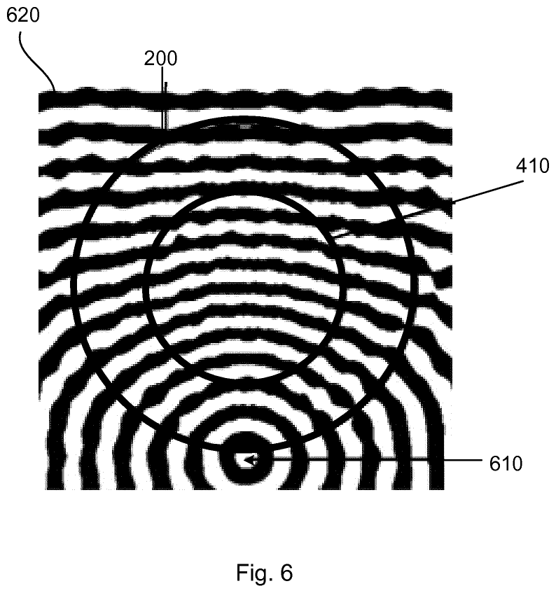

A Luneburg lens built up by placing glide-symmetrically the parallel plate unit cell 100a described in FIG. 2 has been simulated. FIG. 6 schematically illustrates use of a parallel plate arrangement 200 as an antenna lens according to an embodiment. In more detail, FIG. 6 shows that a plane wave 620 is obtained at one side of the parallel plate arrangement 200 when feeding an opposite side of the parallel plate arrangement 200 with a discrete source 610. Therefore, the parallel plate arrangement 200 can be used to create a structure that modulates the refractive index taking into account assembly flexibility since the gap g is now mechanically stable.

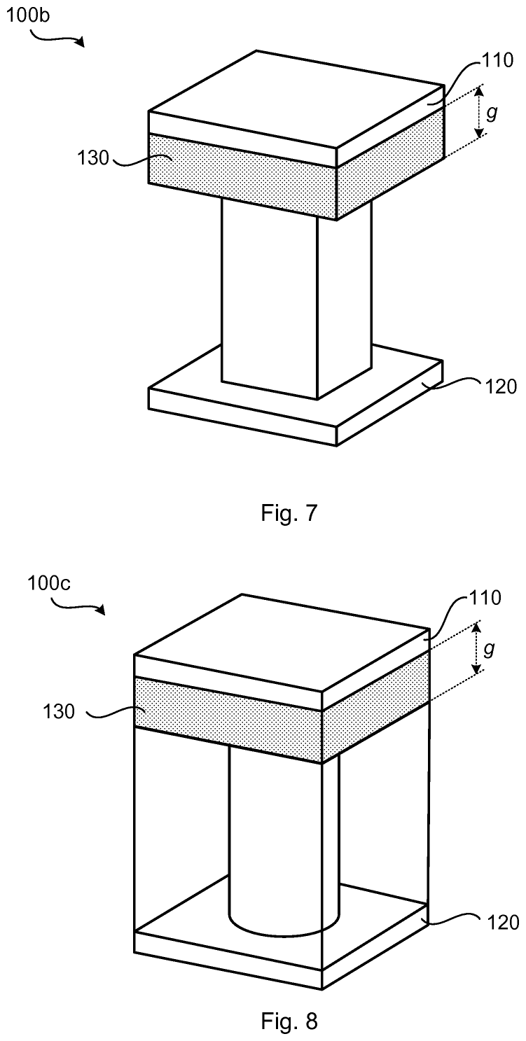

The herein disclosed embodiments are not limited to parallel plate unit cells as illustrated in FIG. 2 (and thus not only for holey glide-symmetric unit cells). The parallel plate unit cell could be composed of another type of unit cell, for example pins or via holes taking into account a parallel-plate configuration. FIG. 7 illustrates an embodiment of a parallel plate unit cell 100b being provided as a square pin unit cell. FIG. 8 illustrates an embodiment of a parallel plate unit cell mob being provided as a via hole unit cell. There could thus be different types of parallel plate unit cells 100a , mob, 100c that could be used in the parallel plate arrangement 200. Non-limiting examples of parallel plate unit cells 100a , mob, 100c are holey unit cells (such as in FIG. 2), square pin unit cells (such as in FIG. 7) and via hole unit cells (such as in FIG. 8).

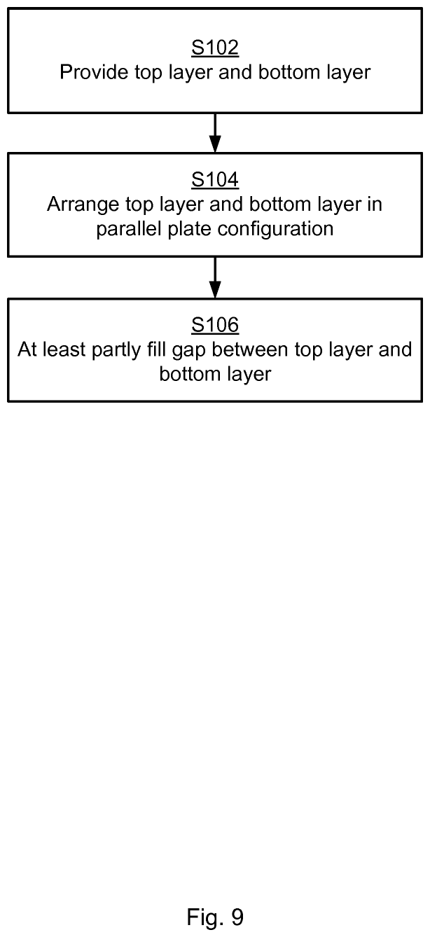

FIG. 9 is a flowchart illustrating an embodiment of a method of manufacturing a parallel plate unit cell 100a , 100b, 100c as herein disclosed.

S102: The top layer 110 and the bottom layer 120 of the parallel plate unit cell 100a , mob, 100c are provided.

S104: The top layer 110 and the bottom layer 120 are arranged in the parallel plate configuration with respect to each other. That is, the top layer 110 and the bottom layer 120 are arranged in a parallel plate configuration with respect to each other such that the metasurfaces 140, 150 face each other.

S106: The gap g is at least partly filled with the material 130 having a refractive index n1, where n1>1.2.

In some aspects the method further comprises arranging at least one parallel plate unit cells 100a, 100b, 100c as herein disclosed and at least one other parallel plate unit cell 10, 100a, 100b, 100c as herein disclosed (but wherein the gap g at least partly is filled with a material having a refractive index n₃, where n3≠ n1) in a parallel plate arrangement 200.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A parallel plate unit cell for a parallel plate arrangement, comprising:
a top layer; and
a bottom layer, wherein
the top layer forms part of a first metasurface,
the bottom layer forms part of a second metasurface,
the top layer and the bottom layer are arranged in a parallel plate configuration with respect to each other such that the first and second metasurface face each other,
the top layer and the bottom layer are physically separated by a gap, and
the gap is filled at least partly with a material having a refractive index n1, where n1>1.2.

2. The parallel plate unit cell of claim 1, wherein the gap is fully filled with the material.

3. The parallel plate unit cell of claim 1, wherein the gap only partly is filled with the material.

4. The parallel plate unit cell of claim 3, wherein the material is a first material, wherein the refractive index n1 is a first refractive index, and wherein the gap is partly filled with a second material having a second refractive index n2, where n2>1.2, and where n2≠n1.

5. The parallel plate unit cell according to claim of claim 1, where n1≥1.5, preferably n1≥1.7.

6. The parallel plate unit cell of claim 1, wherein the metasurface of the bottom layer is glide-symmetrically arranged with respect to the metasurface of the top layer.

7. The parallel plate unit cell of claim 1, wherein the metasurface of the bottom layer exhibits a first recess, wherein the metasurface of the top layer exhibits a set of second recesses, and wherein the set of second recesses is glide-symmetrically arranged with respect to the first recess.

8. The parallel plate unit cell of claim 7, wherein each recess in the set of second recesses as well as the first recess has a depth d, the depth d taking a value in the interval [0.1 mm, 1.0 mm].

9. The parallel plate unit cell of claim 1, wherein the material is a dielectric material, a magnetic material, or a metamaterial.

10. The parallel plate unit cell of claim 1, wherein the parallel plate unit cell is a holey unit cell, a square pin unit cell, or a via hole unit cell.

11. The parallel plate unit cell of claim 1, wherein the top layer and the bottom layer are of a metal material.

12. A parallel plate arrangement comprising:
a first parallel plate unit cell comprising: a first top layer; and a first bottom layer, wherein the first top layer forms part of a first metasurface, the first bottom layer forms part of second metasurface, the first and second metasurfaces face each other, the first top layer and the first bottom layer are physically separated by a first gap, and the first gap is filled at least partly with a material having a refractive index n1, where n1>1.2; and
a second parallel plate unit cell comprising: a third top layer; and a third bottom layer, wherein the third top layer forms part of a third metasurface, the third bottom layer forms part of fourth metasurface, the third and fourth metasurfaces face each other, the third top layer and the third bottom layer are physically separated by a third gap, and the third gap is filled at least partly with a material having a refractive index n3, where n3 does not equal n1.

13. The parallel plate arrangement of claim 12, wherein the parallel plate arrangement comprises a plurality of first parallel plate unit cells and a plurality of second parallel plate unit cells.

14. The parallel plate arrangement of claim 13, wherein the first gap separating the top layers and the bottom layers of all the first parallel plate unit cells at least partly is filled by a disk of the material having the refractive index n1.

15. The parallel plate arrangement of claim 14, wherein the material is a first material, wherein the refractive index n1 is a first refractive index, wherein the disk is a first disk, wherein the gap separating the top layers and the bottom layers of all the first parallel plate unit cells only partly is filled by the first disk, and wherein the gap of at least some of the first parallel plate unit cells further is partly filled by a second disk of a second material having a second refractive index n2, where n2>1.2, and where n2≠n1.

16. The parallel plate arrangement of claim 12, wherein the metasurfaces of each of the bottom layers are glide-symmetrically arranged with respect to the metasurfaces of each of the top layers.

17. The parallel plate arrangement of claim 12, wherein the metasurface of each bottom layer exhibits a first recess, wherein the metasurface of each top layer exhibits a set of second recesses, and wherein the set of second recesses is glide-symmetrically arranged with respect to the first recess.

18. The parallel plate arrangement of claim 17, wherein each recess in the set of second recesses as well as the first recess has a depth d, the depth d taking a value in the interval [0.1 mm, 1.0 mm].

19. The parallel plate arrangement of claim 18, wherein the parallel plate arrangement comprises parallel plate unit cells with mutually different values of the depth d.

20. The parallel plate arrangement of claim 12, where n3<1.2.

21. The parallel plate arrangement of claim 12, wherein the parallel plate arrangement forms an antenna lens, wherein the antenna lens is one of a Luneburg lens, a Maxwell fish eye lens, a Gutman lens, an Eaton lens, a 90 degrees rotation lens, an invisible sphere lens, or an optically transformed lens.

22. A method of manufacturing a parallel plate unit cell, according to comprising a top layer and a bottom layer, wherein the top layer forms part of a first metasurface and the bottom layer forms part of second metasurface, the method comprising:
arranging top and bottom layers so that the first and second metasurfaces face each other and the first top layer and the first bottom layer are physically separated by a gap; and
filling the first gap at least partly with a material having a refractive index n1, where n1>1.2.
